(19) United States
(12) Patent Application Publication
(10) Pub. No.: US 2005/0089468 A1
(43) Pub. Date: Apr. 28, 2005

(54) Process for improved carbon black furnace reactor control and utilization of flue gas as reactor fuel

(76) Inventors: Robert W. Wansbrough, Houston, TX (US); David Pacobit, Katy, TX (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/690,881

(22) Filed: Oct. 22, 2003

(51) Int. Cl. C01D 3/00

(52) U.S. Cl. 423/449.1; 423/450

(57) ABSTRACT

Process control of a furnace-type carbon black reactor can be improved if certain process conditions are maintained. Principal among these are the calculated combustion gas temperature and the percentage or absolute amount of oxygen present within the combustion gases at a point just upstream of the feedstock oil injection point. Desired conditions can be obtained by adjusting the amount of oxygen enrichment in the oxidizer stream. A computer-based, mathematical model of a carbon black process indicates that such process control would enable the use of flue gas as fuel for a furnace-type reactor and that the oxygen enrichment of the oxidizer stream needed to obtain the same combustion gas temperature and oxygen content as that produced with hydrocarbon fuel provides the same heat input rate above an arbitrary datum such as 77° F. at that combustion temperature and about the same combustion gas volume at the feedstock oil injection point as that obtained with a conventional hydrocarbon fuel.

### CROSS-REFERENCE TO RELATED APPLICATIONS

### BACKGROUND OF THE INVENTION

1. Field of the Invention

This invention relates to a process for improved carbon black reactor control in a furnace-type reactor, which enables the flue gas from the process to replace the conventional hydrocarbon reactor fuel. Reactor performance is maintained by adding supplemental oxygen to the oxidizer stream to provide the same combustion temperature, the same oxygen content, the same heat input rate above an arbitrary datum such as 77° F. at that combustion temperature, and about the same combustion gas volume at the feedstock oil injection point.

2. Description of the Related Art

Carbon black is a finely divided form of carbon, practically all of which is made by burning and pyrolyzing vaporized heavy-oil fractions (“feedstock oil”) similar to fuel oil in a furnace with about 50% of the air (oxygen) required for complete combustion (partial oxidation). This type of carbon black is also called furnace black. Carbon black can also be made from methane or natural gas by cracking (“thermal black”) or direct combustion (“channel black”), but these methods are virtually obsolete. All types are characterized by extremely fine particle size, which accounts for their reinforcing and pigmenting effectiveness.

The principal use of carbon black as industrial carbon is in the manufacture of rubber. The abrasion resistance of natural rubber is poor unless it is compounded with carbon black. Other uses of carbon black include as a colorant for printing inks, and as a reinforcing agent, opacifier, electrical conductor, and/or UV-light absorber for plastics.

Various tests may be used to characterize carbon black and to estimate its general performance in elastomeric compounds. Among these tests are: Iodine Number—a test useful in characterizing carbon blacks which relates to the surface area; Nitrogen Surface Area—a test method used to measure the surface area of carbon black that is available to nitrogen molecules; Oil Absorption Number [OAN]—a measurement of carbon black structure (the degree and geometry of interlinking among carbon black aggregates) as measured by the absorption of oil with higher values correlating to higher structure; Toluene Discoloration—a test which compares the transmittance at 338 nm of a filtrate obtained from a toluene extract of carbon black to that of pure toluene; Tint—a test which provides an indication of relative particle size with higher numbers correlating to smaller particle size and greater hiding power; Heating Loss—the percentage of moisture remaining in the product after pelletizing and drying; Sieve Residue—the amount (in parts-per-million) of contaminants remaining in the product as determined by water-washing a sample through a standard size screen; Fines—that portion of pelletized carbon black-that passes through a standard screen size when the product is shaken in a mechanical sieve shaker; and, Density—the mass per unit volume of the pelletized carbon black product.

Modern carbon black reactors share similar characteristics, particularly for making tread grade blacks. Fuel of some sort of hydrocarbon is injected into a stream of preheated air. The fuel and air, sometimes enriched with oxygen, are combusted in a combustion chamber under stoichiometric excess oxygen conditions. Combustion is preferentially complete to carbon dioxide and water. The composition of the combustion gas and the resulting combustion (flame) temperature can be easily calculated by those skilled in the art of thermodynamics, by assuming the desired complete combustion. Neglecting the small heat loss from the combustion section, the sum of the enthalpies of all input streams and the product combustion gas above a reference temperature (usually 77 degrees Fahrenheit) plus the resulting combustion gas enthalpy change must be zero. This follows from the state function property of enthalpy.

In typical reactors, the hot combustion gases are introduced into a smaller throat section that forces them up to velocities of some considerable fraction of supersonic velocity, said velocity having been found by every carbon black maker to be desirable for efficient carbon black production. Preheated feedstock oil is injected into this throat section in one or more planes. Sometimes it is also desirable to inject some portion of the feedstock into an expanded tunnel section downstream of the throat section. Care is taken in this feedstock injection to inject enough feedstock oil to move the resulting mixture from fuel-lean to fuel-rich conditions, since a stoichiometric mixture of combustion gas and feedstock oil would produce temperatures far in excess of most reactor refractory limits.

Combustion of feedstock oil with the remaining oxygen and the heat content of the combustion gas raise the remaining feedstock oil to temperatures necessary to form growth nuclei and to pyrolyze the feedstock oil to carbon black, producing a “smoke” (aerosol) of very small carbon black particles and a gas rich in nitrogen, hydrogen, carbon oxides, and water, with small amounts of methane and acetylene, and even smaller amounts of hydrogen sulfide, etc. This smoke is usually quenched with water to stop further undesirable reactions.

In typical carbon black plants, the smoke stream is further cooled by heat exchange to preheat the reactor feed air/O₂ mixture and the feedstock oil, then passed through filters of some kind to remove the carbon black product. The resulting flue gas, which typically contains one-third water, even at the typical 450° F., has a calorific value less than about 150 BTU/scf (British thermal units/standard cubic foot of gas) and is not highly valued. In this country, some small percentage of it is used for drying operations and the rest is burned to oxidize carbon monoxide and hydrogen sulfide to carbon dioxide and sulfur dioxide respectively and emitted to the atmosphere from a tall stack. However, there has been some recent interest in waste heat recovery from this resource in the United States.

One, particularly preferred, carbon black reactor for use in practicing the process disclosed herein is described in U.S. Pat. No. 4,988,493 to Norman, et al. The entire disclosure of this patent is incorporated herein by reference.

The carbon black reactor shown in FIG. 1 is a modular type reactor. The term modular is used to denote that the reactor is composed of modules or sections, each having a specific function, with the modules joined together sequentially so as to provide a means to carry out the carbon black manufacturing process in a continuous stepwise manner.

In longitudinal sequence, the particular reactor shown in FIG. 1 is divided into four sections or modules. Section 1 is a combination air distribution and combustion zone, Section 2 is a carbon black feedstock oil injection zone, Section 3 is a reaction zone, and Section 4 is a reaction quench zone.

In operation, preheated air for combustion may be supplied to the carbon black reactor under sufficient pressure to overcome the pressure drops encountered in the reactor and downstream equipment. This air enters the reactor through conduit 5 and into the annular space 6 between outer reactor shell 7 and the inner combustion chamber shell 8. The air may then travel in a direction toward the reactor head 9 through the annular space 6 between the outer and inner shells, 7 and 8.

Multiple longitudinal vanes 10 may be located in the annular space 6. These vanes 10 may be rigidly attached to the inner combustion chamber shell 8 and serve three purposes. Firstly, they may impart a linear, non-swirling, flow direction to the air stream. Secondly, they may provide heat transfer surfaces to conduct heat from the refractory lining 11 surrounding the combustion zone 1, through the inner shell 8 and vanes 10 into the air stream. This heat transfer may further serve to partially cool the refractory lining 11 and allow higher combustion temperatures to be maintained in combustion zone 1. Thirdly, the vanes 10 may provide a mechanical support to keep the inner combustion chamber shell 8 concentrically located inside the reactor outer shell 7.

After passing through the vaned portion of annular space 6, the combustion air may be passed through an air plenum chamber 12, located adjacent to the reactor head 9, and thence into the combustion zone 1 through a concentric circular orifice 13, located at the upstream end of combustion zone 1.

A fuel injection device 14, mounted in the reactor head 9 may be provided to inject and disperse a hydrocarbon fuel into the combustion air stream as it passes through orifice 13 and into combustion zone 1. The fuel used may be either a liquid or gaseous hydrocarbon. When a liquid hydrocarbon is used as a fuel, it is normal practice to preheat the fuel to increase its rate of vaporization for more rapid ignition. Gaseous hydrocarbon fuels may be injected at or near ambient temperatures without encountering delayed ignition problems. It is also normal practice to inject a small amount of air into the injection device to cool it and protect the metallic components of the fuel injection device from overheating damage.

It is desirable to maintain as high a combustion temperature as possible in the combustion zone 1 of the reactor, consistent with staying within the temperature service limits of the refractory linings in the reactor. Refractory linings of essentially pure alumina or composite aluminum oxide—chromic oxide refractories may be used for this service.

The air preheat temperature and fuel injection rates used are typically selected to result in a theoretical flame (combustion) temperature of about 3000 to 3500° F. (˜1650 to 1900° C.) in the combustion zone 1 of the reactor.

In addition to maintaining a high combustion temperature in the reactor combustion zone 1, it is desirable to have some excess oxygen available after complete combustion of the fuel added through fuel injection device 14. This excess oxygen may be consumed in the carbon black feedstock oil injection zone 2 of the reactor by burning a portion of the carbon black feedstock oil injected in zone 2. It is contemplated that this additional combustion of feedstock hydrocarbons may not only provide supplemental heat input into the carbon black forming process, but may also generate large numbers of combustion nuclei, upon which carbon black particles may form.

The combustion chamber in section or zone 1 of the reactor may be formed in a conical shape with its maximum diameter at the upstream end of zone 1 and continuously decreasing in diameter in a downstream longitudinal direction, so as to continuously increase the velocity of the gaseous process stream as it moves in a downstream direction. The volumetric capacity of the combustion zone 1 may be sufficient to allow time for complete combustion of the fuel injected into the air stream through the fuel injection device 14. Other combustion chamber shapes may be used advantageously by those skilled in the art, but the conical shape shown provides a practical means of providing a uniform, linear (non-swirling) flow of hot combustion process gases into the feedstock oil injection zone 2 of the reactor.

The feedstock oil injection Section 2 may be a refractory lined zone consisting of a hot face refractory lining 11 of the same refractory material used in the upstream combustion zone 1. The hot face refractory lining 11 may be encased in an insulating refractory material 15 to protect the section shell 16 from excessive temperatures.

The internal shape of the feedstock oil injection zone 2 may be divided into two portions. The upstream portion 23 may be a continuation of the internal conical shape of the combustion zone 1. The downstream portion 24 of Section 2 may be a concentric cylindrical throat of fixed diameter.

The feedstock oil injection zone 2 may contain two or more sets of feedstock oil injection nozzles 17, with each set of nozzles 17 being longitudinally and laterally spaced apart from each other. It is preferred to install one set of feedstock oil injection nozzles 17 in the cylindrical throat portion 24 of Section 2, and to install one or more sets of feedstock oil injection nozzles in the upstream conically shaped portion 23 of Section 2.

Each set of feedstock oil injection nozzles 17 may consist of multiple hydraulic or gas atomizing nozzles uniformly spaced around the internal periphery of the reactor cross section and directed radially inwardly and generally perpendicular to the longitudinal centerline of the reactor. Instead of a right angle one may direct the nozzles and/or spray at other suitable angles e.g. 10°, 20°, 45°, 60°, 75°, from the right angle and these may be in both directions from the normal.

The selection of which set of feedstock oil injection nozzles to be used may be partially determined by the “structure” desired in carbon black product being produced. Carbon black “structure” is a relative term relating to the degree of aggregation of carbon black particles to form aggregates in the carbon black product being produced. Carbon black “structure” may be measured effectively by American Society for Testing and Materials (ASTM) Methods D-2414 and/or D-3493.

Carbon black products of lesser structure are normally produced by injecting carbon black feedstock oil into portion 24 of zone 2, where maximum velocity of the process gas stream may occur. Carbon black products of increased structure are normally produced by injecting the carbon black feedstock oil into portion 23 of zone 2, where lower process gas stream velocity may occur. When only two sets of feedstock oil injection nozzles are provided in the reactor, it is customary to locate one set of nozzles 17 in portion 24 of Section 2, and to locate the additional set of nozzles 17 at a point in portion 23 of Section 2, where the internal cross sectional area of the reactor may be twice the internal cross sectional area of portion 24 in Section 2. It is well known to those skilled in the art that further adjustments of structure may be made by the addition of alkali metal salts into the combustion zone 1 of the reactor. Potassium chloride is one particular salt that is commonly used for this purpose.

It is normal practice to utilize only one set of feedstock oil injection nozzles when producing conventional grades of carbon blacks. Carbon black feedstock oil, preheated to near its initial boiling point, may be radially injected inwardly through multiple feedstock oil injection nozzles 17 into the hot process gas stream generated in the combination zone 1 of the reactor. Feedstock oil injection nozzles 17 may be selected of proper size and spray angle to effect uniform distribution of atomized oil droplets over as much of the reactor internal cross section as can be practically achieved.

It is believed that this method of carbon black feedstock oil injection forces rapid and intimate contact between the atomized feedstock oil droplets and the high temperature combustion gas process stream flowing from zone 1 of the reactor. This may result in rapid vaporization of the carbon black feedstock oil, thermal dissociation of hydrogen from the feedstock oil hydrocarbons, and pyrolysis of the hydrogen deficient feedstock oil hydrocarbons into pyrolysis products of very high molecule weight.

Referring now to FIG. 1, these reactions, initiated in Section 2 of the reactor, continue at a very rapid rate as the reactant mass flows into and through section or zone 3 of the reactor. Reaction zone 3 may be a cylindrical section, having an internal diameter approximately twice the internal diameter of portion 24 of zone 2. This reaction has hot face refractory lining 11, encased inside an insulating refractory lining 18, and enclosed by the external reactor shell 19.

As the endothermic process reactions continue in reaction zone 3 of the reactor, the reactant mass starts to cool and condensation of the pyrolized reaction products starts to occur on the surface of combustion nuclei generated primarily in zone 2 of the reactor. Condensation of the pyrolized reaction products creates very small spherical particles, which continue to grow in size as long as condensable pyrolysis products are available. Highly turbulent flow conditions may be encountered in reaction zone 3, due to eddy currents created by the sudden enlargement of reactor internal diameter between zone 2 and zone 3.

The further dehydrogenation of particles may continue to occur gradually as the reactant mass proceeds downstream into quench section or zone 4 of the reactor. Dehydrogenation may be finally terminated in zone 4 by cooling the reactant mass below the temperatures required for dehydrogenation.

This cooling of the reactant mass may be accomplished by spraying water directly into the process stream through one or more quench spray nozzles 22 in reaction quench section or zone 4. This water is rapidly evaporated, thus cooling the process stream by heat absorption.

Reaction quench zone 4 may consist of multiple cylindrical sections, lined with a temperature and spall resistant refractory lining 20, and encased in reactor shell sections 21. Multiple quench spray ports 22 may be provided along the longitudinal length of zone 4, so that reaction residence times may be adjusted by quench position.

After cooling the process stream by quenching with water, the process stream containing entrained carbon black, may flow to conventional downstream equipment where further heat transfer and separation of the carbon black from the remainder of the process stream may be accomplished by conventional means. Those skilled in the art are familiar with the required downstream operations.

In the present state of the art, control of the reactor to produce the least variation in the carbon black properties is achieved mainly by keeping the inputs as constant as possible. Total air rate and preheat temperature, added oxygen rate and preheat temperature, fuel rate, feedstock rate, and structure control additive are control variables that are maintained closely to provide desired iodine number (ASTM D-151 0), nitrogen surface area (ASTM D-3037), OAN (ASTM D-2414), and tint (ASTM D-3265). Preheat temperature(s) are maintained as constant as possible, but fouling and other factors make this a little more difficult. Current practice is to control to a constant calculated combustion temperature of the combustion chamber gas into which the feedstock is injected. This is usually accomplished by adjusting the fuel rate while holding the air and oxygen rates as constant as possible.

Unfortunately, the carbon black properties enumerated above are not measured on-line. Samples must be collected somewhere in the downstream equipment and determined in laboratory analyses. Usually, the operator, upon obtaining iodine number measurements, adjusts the feedstock rate upward for iodine number too high, and vice-versa. He then finds that his structure, as measured by OAN, has changed and must also change the additive rate. This is not a very satisfactory situation, since holdup in the downstream pelletizing equipment is measured in hours. This plus the laboratory analysis time, leads to less than optimal quality control. Part of the present invention improves on this.

A furnace-type carbon black reactor can be automatically controlled using a processor-based system operating under program control. The operating parameters may include the oxygen enrichment of the oxidizer stream, the air feed rate, the feedstock oil feed rate and the air/O₂ preheat temperature. Inputs to such a processor-based system may include fuel temperature, fuel feed rate, and oxygen feed rate. Operating in a feedback loop, the processor-based system may be programmed to vary the operating parameters so as to produce a desired combustion gas temperature at a selected point in the reactor. One particularly preferred point is the feedstock oil injection point. Using techniques known in the art, the combustion gas temperature and oxygen concentration may be calculated from the measured input parameters and the known enthalpies of the input streams and heats of combustion. In this way, the system attempts to compensate for changing conditions and maintain product quality.

U.S. Pat. No. 4,393,034 to Smith describes a method of producing carbon black which employs recycled flue gas from the process as the reactor fuel. The fuel is combusted in the presence of a stoichiometrical excess of an oxidant gas containing at least 70% and more preferably in excess of about 80% oxygen. Optimum overall economics are said to be afforded with the production of 90-95% oxygen for use in the process. Preferably, the excess oxygen ranges from 40 to 70% above the stoichiometrical requirement for combusting the fuel feed.

The use of such a rich oxidant gas gives rise to substantially higher stiochiometric combustion temperatures than those encountered when air is used as the oxidant gas. The use of pure [or nearly pure] oxygen as the oxidant gas can generate temperatures in excess of that which conventional refractories can withstand over an extended period of operation unless fuel-lean conditions are maintained. When feedstock is added and conditions are changed from fuel-lean to fuel-rich, very hot local hot spots are possible. Accordingly, Smith teaches the use of a reactor shell fabricated from a heat-resistant steel, dispensing with the refractory lining and in turn providing means for cooling the surface of the reactor with a heat-conducting medium, preferably water, with a resulting heat loss. The apparatus described by Smith has satellite reactors that utilize air as the oxidant gas as opposed to the use of oxygen in the primary reactor and these satellite reactors are refractory lined. The higher operating temperatures of the primary reactor are said to favor the production of tread or abrasion-resistant black {HAF} rather than carcass black {GPF}.

The flue gas from the primary reactor from which the condensable gas content in the form of steam is removed is indicated as having an energy content of 270 BTU/scf and to be comprised of about 44% hydrogen, 37% carbon monoxide, 17% carbon dioxide, with the balance being methane and acetylene.

The total off-gas stream is said to be somewhat in excess of twice that needed for recycle purposes and the excess flue gas is combusted with air in the operation of a tandem carbon black reactor or reactors. The off-gasses of the tandem reactor(s) are preferably enriched with the excess flue gas from the primary reactor to operate the driers.

### SUMMARY OF THE INVENTION

It has been discovered that a portion of any flue gas from a carbon black furnace reactor is sufficient to produce the requisite reactor combustion temperature if the amount of diluents in the oxidizer stream is reduced—i.e., the typical natural gas/air fuel system can be replaced with a flue gas/oxygen enriched air fuel system. Surprisingly, a little oxygen enrichment and air/flue gas rate decreases can generate the same crucial conditions at the feedstock oil injection point of the reactor as with the replaced fuel. The replacement of relatively expensive natural gas or liquid hydrocarbon fuel with less expensive process-generated fuel and additional oxygen can provide a net reduction in the overall process cost. Moreover, elimination of a hydrocarbon fuel reduces environmental pollution from greenhouse gasses such as carbon dioxide which are invariably produced in the combustion of hydrocarbon fuels.

The present invention is a process for producing furnace carbon blacks that allows the previously used fuel, that creates a hot combustion gas into which the feedstock oil is injected, to be replaced by recycled flue gas with an appropriate amount of added oxygen and reduced air to achieve substantially the same injection conditions and thereby the same carbon black production rate and yield. A computer-based, mathematical model of a furnace-type carbon black process (that matches numerous plant and pilot plant results) indicates that this may be achieved by adjusting the amount of air, oxygen, and flue gas fuel to achieve at the feedstock injection point:
The same combustion temperature of the combustion gas,
The same percent oxygen in the combustion gas, and
The same heat input rate above an arbitrary datum such as 77° F. at that combustion temperature
And, because of the three previous maintained controls, the same volumetric heat rate at the feedstock injection point;
Very nearly, the same volume of gas at the feedstock injection point,
And only slightly different amounts of carbon dioxide, nitrogen and water at the feedstock injection point.

Because these parameters determine the performance of a carbon black reactor (other reactor parameters such as feedstock injection type and rate, etc. remaining the same), the required feedstock rate to make the carbon black grade remains the same and production and yield are little affected.

Methods of the prior art have utilized a flue gas introduction rate adapted to provide a combustion temperature of about that associated with the burning of a conventional hydrocarbon fuel while concomitantly introducing substantially the same stoichiometric excess of the oxidant gas. In contrast, our model indicates that product quality is better controlled if, in addition to maintaining the combustion temperature, the oxygen concentration in the combustion gas stream at or near the feedstock injection point is kept nearly constant.

### BRIEF DESCRIPTION OF THE DRAWINGS

FIG. 1 is a longitudinal sectional view of a typical carbon black reactor or furnace which may be used to carry out the process described in this invention.

FIG. 2 is a block diagram of a carbon black process which employs one particular embodiment of the invention.

### DETAILED DESCRIPTION OF THE INVENTION

We have discovered, using a computer model that matches numerous plant and pilot plant results, that carbon black product quality variation can be much reduced if, in addition to maintaining a constant input air rate and calculated combustion temperature in the combustion chamber, the calculated oxygen concentration at the feedstock oil injection point is also kept constant. (This is a subset of the case of a variable BTU/scf fuel; see below.) Table 1 illustrates this situation for ASTM grade N326 carbon black produced in a furnace-type reactor fueled with natural gas and using one particular feedstock oil. Example 1 is the base case for making specification black properties of iodine number, nitrogen surface area, tint and structure. With the air/O₂ stream preheated to 1200° F., and with 1% oxygen enrichment (i.e., if the incoming air is 21% oxygen, it is enriched to a total of 22% oxygen), the calculated percentage of oxygen in the combustion gas at the feedstock oil injection point is 10.74%.

If the preheat temperature is reduced to 1100° F. (Example 2), all of the carbon black product properties except OAN would be out of specification—e.g., the iodine number drops 5 units to 76.1. If no correction is made to fuel rate, the combustion temperature would decrease to 2925° F. Example 3 represents the conventional correction, namely increasing the fuel rate to bring the combustion temperature back up to 3004° F. This would actually increase the error, as measured by the iodine number which would decrease to 73.4.

Example 4 represents the preferred correction in accordance with the present invention—the calculated percentage of oxygen and the calculated combustion temperature are both returned to the values of the base case (Example 1). The calculated result is the carbon black properties would be very close to the desired Example 1 values, with no feedstock oil feed rate or additive changes necessary. This represents a significant improvement over the present state-of-the-art control schemes. It will be observed that this control scheme is equivalent to maintaining a constant heat input rate at a constant combustion temperature, or even a constant heat input rate per unit volume total input gas flow rate at constant combustion temperature with the same amount of oxygen available to subsequently burn the feedstock oil. Heat input rate is defined here as the enthalpy input rate, MMBtu/hour above the reference 77° F. delivered to the feedstock injection point (but not including the feedstock oil). The terms that make it up are the air preheat above 77° F., the oxygen preheat above 77° F., the fuel preheat above 77° F., and the heat of complete combustion of the fuel at 77° F. These terms, of course, sum to the enthalpy change of the products of combustion between 77° F. and the combustion (flame) temperature. Volumetric heat input is the BTU/scf at the feedstock oil injection point. Only Example 4 matches Example 1 in these respects.

TABLE 1

Example No.

| | 1 | 2 | 3 | 4 |
|---|---|---|---|---|
| % O₂ Enrichment | 1.0 | 1.0 | 1.0 | 1.54 |
| Oxygen rate, | 1.80 | 1.80 | 1.80 | 2.80 |
| MSCFH | | | | |
| Air rate (MSCFH) | 140.5 | 140.5 | 140.5 | 140.5 |
| Feedstock oil rate | 353 | 353 | 353 | 353 |
| (GPH) | | | | |
| Air + O₂ Feed | 1200 | 1102 | 1102 | 1102 |
| Preheat (° F.) | | | | |
| Fuel rate | 7.6 | 7.6 | 7.9 | 8.0 |
| (MSCFH) | | | | |
| % Excess oxygen | 107 | 107 | 97 | 102 |

Combustion gas conditions at feedstock injection point

| | | | | |
|---|---|---|---|---|
| Combustion temp | 3004 | 2925 | 3004 | 3004 |
| (F.) | | | | |
| % O₂ | 10.74% | 10.74% | 10.20% | 10.71% |
| Heat input above | 9.75 | 9.46 | 9.81 | 9.88 |
| 77°(F.), | | | | |
| MMBTU/hr | | | | |
| Volumetric heat | 64.63 | 62.73 | 64.85 | 64.86 |
| input, BTU/scf | | | | |

Pelletized carbon black properties

| | | | | |
|---|---|---|---|---|
| iodine number | 81.2 | 76.1 | 73.4 | 81.9 |
| Nitrogen surface | 78.0 | 73.1 | 70.3 | 78.7 |
| area (m²/gm) | | | | |
| Tint | 105.4 | 101.5 | 99.5 | 105.9 |
| OAN | 72.0 | 71.1 | 71.1 | 72.2 |

As a further surprising aspect of the invention, we calculate that just about any fuel of low calorific value could be used if augmented by appropriate oxygen enrichment to produce the same percentage of oxygen in the combustion gas at the same combustion temperature. These conditions will produce almost the same total volume of input gases as when natural gas or liquid hydrocarbon fuels are used—i.e. high BTU/scf fuels. As a result, the capacity of downstream equipment such as bag filters need not be modified. In particular, a portion of the flue gas taken from the usual bag filters can be used as the fuel, with or without water removal, so long as air, oxygen, and flue gas fuel rates are adjusted to maintain the same combustion temperature, the same percent oxygen at the feedstock injection point, and the same heat input rate. Since the total gas volumes at the feedstock injection point are projected to stay surprisingly constant when this is done, the volumetric heat input rate will also stay the same. The net result of this is that one can use the combustible components of the low BTU fuel with a “synthetic air” that provides nearly the same combustion gas parameters within the reactor. Since the resulting combustion gas is calculated to differ only slightly in composition with a little more carbon dioxide and less nitrogen (depending largely on the amount of water removed), production rates and product quality should also differ little. Since roughly half as much air is required, and is replaced by approximately the same volume of flue gas, it could be stated that the net result of the process is the same as if the associated quantity of nitrogen were removed from the recycled flue gas.

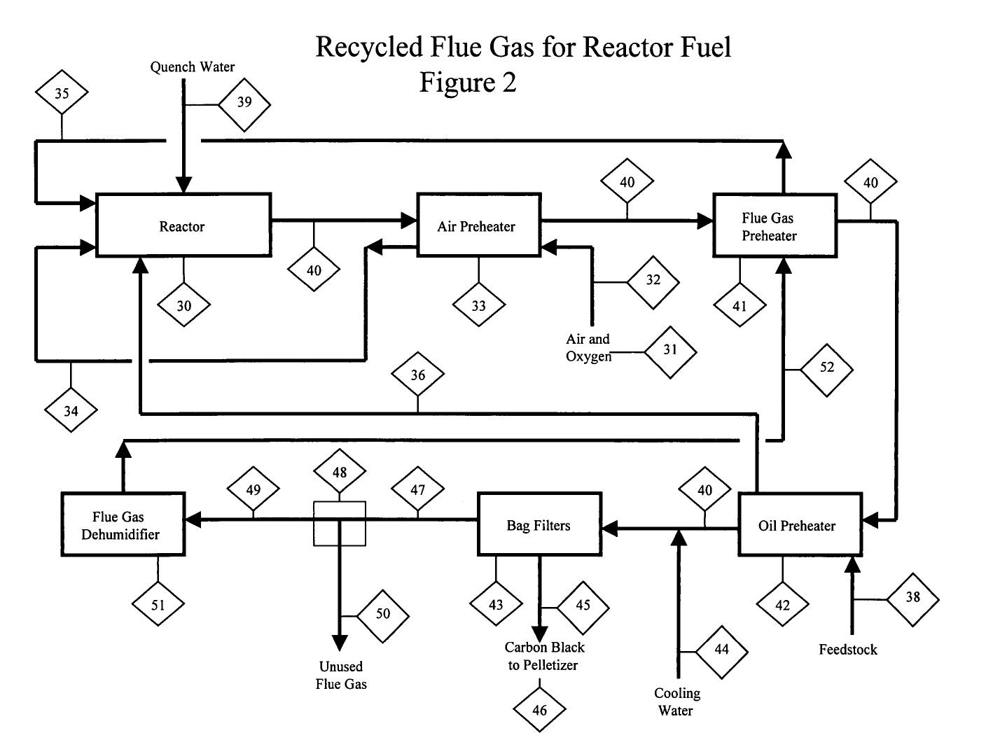

FIG. 2 illustrates one particular embodiment of the invention in block diagram form. Carbon black furnace reactor 30 is supplied with fuel via line 35, an oxidant stream via line 34 and feedstock oil via line 38. Quench water from supply 39 is added to the reactor effluent, the smoke stream is further cooled by heat exchange with air and oxygen in air preheater 33, dehumidified flue gas in flue gas preheater 41, and feedstock oil preheater 42. The reactor effluent is then sent to separation equipment such as bag filters 43. Additional cooling water from cooling water supply 44 may be added in effluent line 40 to further cool the effluent to a temperature which will not damage the separation equipment. The flue gas from the bag filters 43 may be separated in splitter 48 into an exhaust stream 50 and a recycle stream 49. The flue gas separated from the carbon black product and recycled may be dehumidified in flue gas dehumidifier 51 and the desired portion is then recycled to the reactor combustion section as fuel after being heated by heat exchange in flue gas preheater 41. Flue gas dehumidifier 51 may remove a portion of the water vapor contained in the flue gas by cooling the flue gas to condense the water. Cooling may be effected by water spray. Since a major combustion product of any hydrocarbon is water, the process generates water which may be recovered and used in cooling water supply 44—a significant advantage in arid regions.

The skilled observer will recognize that the utilization of the flue gas as fuel for the furnace black process is enabled by the appropriate addition of oxygen to adjust the combustion conditions and many configurations of downstream or other ancillary equipment may be employed in practicing the invention. The invention can be applied to any furnace black process that generates a flue gas with combustible components, whether the fuel replaced is natural gas, liquid fuel, or some combination of hydrogen, heavy oil or light hydrocarbons. Moreover, the skilled observer will recognize that it is not necessary to exactly match the conditions of the replaced fuel at the feedstock injection point, but rather these conditions can be varied at will to adjust the reactor production rate to optimize total operations.

Additional fuel should be necessary only at startup before feedstock oil is added to generate both the carbon black product and the flue gas. A dual fuel burner or multiple burners in the reactor may be used. As soon as the unit is heated up and feedstock oil added from feedstock supply 38, the resulting flue gas (and additional oxygen from supply 31) can replace the temporary fuel used during unit startup.

The portion of the flue gas which is not used to fuel the reactor (stream 50 in FIG. 2) may be used for co-generation or to fuel dryers for the pelletized product.

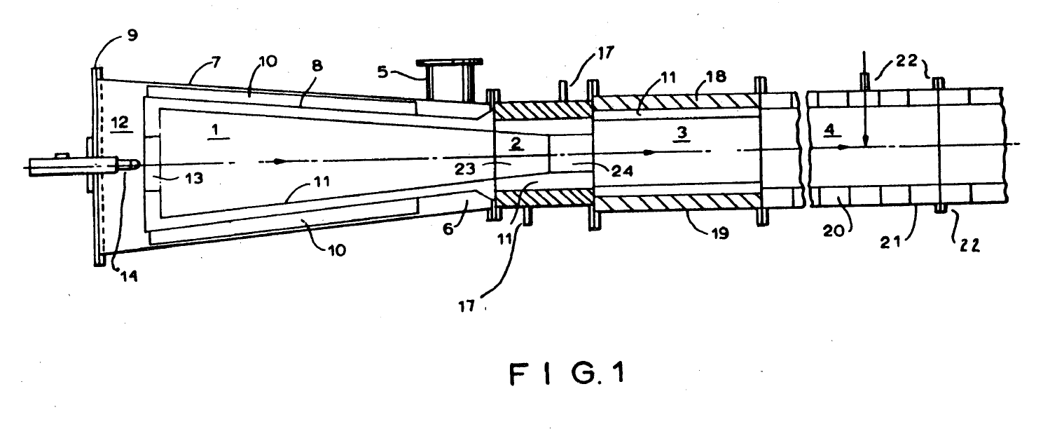

Example 1 in Table 2 represents a computer-simulated process wherein the reactor of FIG. 1 makes carbon black ASTM grade N326 using natural gas as the reactor fuel and represents the current state of the art. Example 2, one preferred embodiment of the improved process, utilizes recycled flue gas dehumidified to approximately 140° F. and preheated, in this example to 1050° F. It will be observed by comparing these two examples that Example 2 is calculated to deliver at the feedstock injection point:
The same combustion temperature of the combustion gas,
The same percentage of oxygen in the combustion gas, and
The same heat input rate above an arbitrary 77° F. as defined herein (obtained by the appropriate amount of flue gas fuel adjustment)
And, the same volumetric heat rate at the feedstock injection point (because of the above, three controls being maintained);
The same volume of gas at the feedstock injection point (to a close approximation); and,
Only slightly differing amounts of carbon dioxide, nitrogen and water at the feedstock injection point.

Because these parameters determine the performance of a carbon black reactor (other reactor parameters such as feedstock injection, etc. being the same), the required feedstock oil rate to make carbon black ASTM grade N326 should remain the same and production and yield should be little affected. These results are not intuitively obvious to one skilled in the art of carbon black furnace reactors. The observer trained in the art will recognize that exchanging 7.5 mscfh of natural gas (“NG”) for 5.8 mscfh of oxygen (7.6 mscfh-1.8 mscfh for the NG-fueled Example 1) represents a considerable cost saving at current prices. The skilled observer will also recognize that this same approach, so long as the control parameters above are maintained, will work just as well for any purity of oxygen available.

Any iterative procedure that simultaneously achieves the above criteria can be used. For example, once the flame (combustion) temperature, percent oxygen in the combustion gas, and heat input generated by the hydrocarbon-fueled base case (e.g., Example 1) are calculated (and the composition of the resulting flue gas measured or predicted by, for example, assuming the desired complete combustion), the conditions necessary to reproduce these criteria with replacement recycle flue gas as the fuel can be calculated by the following procedure:
1. Calculate the resulting flame temperature with the total amount of flue gas fuel and an assumed oxygen enrichment and excess air (oxygen) percentage;
2. Adjust the flue gas input rate to achieve the flame temperature desired;
3. Adjust the air rate, oxygen rate, and fuel rate up or down by the same ratio to obtain the same total heat input rate from fuel combustion, air/O₂ preheat, and flue gas preheat above 77° F. [a temperature datum], MMBtu/hr as the base case with conventional fuel;
4. If the percentage of oxygen at the feedstock injection point is less than the base case amount, increase the amount of oxygen enrichment and repeat steps 1 through 3, above. If the percentage of oxygen at the feedstock oil injection point is too high, decrease the amount of oxygen enrichment and repeat steps 1 through 3, above.

5. Repeat the procedure until the combustion gas temperature, percentage of oxygen in the combustion gas and the heat input rate each approximate that of the base case.

Numerous variations of this iterative procedure will be obvious to those skilled in the art and may be easily implemented using a process control computer. The above-described procedure is not intended to limit the invention since it is clear that any procedure that achieves the desired criteria will work. If what is desired is a larger or smaller carbon black production rate, a larger or smaller percent oxygen at the feedstock injection point can be targeted in step 4 of the above procedure, since the production rate will go up approximately 8 percent for each 1 percent (absolute) increase in this targeted oxygen.

Examples 3 and 4 represent the same comparison but for a process making the higher surface area carbon black, ASTM grade N234. The skilled observer will note that the same comparisons hold; the higher surface area product will only increase slightly the amount of oxygen needed to obtain the same goals.

Example 5, as compared to Example 1, the conventional, natural gas fueled process conditions for making ASTM grade N326, represents a situation wherein the flue gas dehumidification equipment is bypassed. In other words, no water is removed. Flue gas comprising 43.3% water is preheated and fed to the reactor combustion section as fuel. Even in this extreme example, the model indicates that the new invention works, but the additional amount of oxygen required would almost double to 13.3 mscfh from the 7.6 mscfh of Example 2, in which most of the water is removed. The capital and operating costs of the dehumidification equipment would be saved, at the expense of greater oxygen equipment capital and operating costs. Such a choice would be an economic decision.

TABLE 2

| | Example No. | | | | |
|---|---|---|---|---|---|
| | 1 | 2 | 3 | 4 | 5 |
| Product | N326 | N326 | N234 | N234 | N326 |
| Grade | | | | | |
| Feedstock | 353 | 353 | 292 | 292 | 353 |
| oil rate, | | | | | |
| GPH | | | | | |
| air preheat, | 1200 | 1200 | 1198 | 1198 | 1200 |
| deg F. | | | | | |
| Flue Gas | — | 1050 | — | 1050 | 1050 |
| preheat, deg F. | | | | | |
| percent | — | 11.2% | — | 11.2% | 43.3% |
| H₂O in flue | | | | | |
| gas | | | | | |
| recycled | | | | | |
| fraction of | 0.0 | 0.263 | 0.0 | 0.290 | 0.266 |
| flue gas | | | | | |
| recycled as | | | | | |
| fuel | | | | | |
| % O₂ | 1.00% | 5.94% | 1.00% | 6.60% | 13.89% |
| Enrichment | | | | | |
| Oxygen rate | 1.8 | 7.6 | 1.8 | 8.2 | 13.3 |
| (MSCFH) | | | | | |
| Air, mscfh | 140.5 | 93.7 | 140.5 | 90.1 | 62.3 |
| Natural gas, | 7.5 | — | 7.5 | — | — |
| mscfh | | | | | |
| Flue Gas, | 0.0 | 55.63 | 0.0 | 57.82 | 72.82 |
| mscfh | | | | | |
| Total input | 149.9 | 157.0 | 149.8 | 156.2 | 148.5 |
| gas, mscfh | | | | | |
| Mscfh gas | 150.9 | 147.3 | 150.8 | 146.9 | 138.4 |
| at feedstock | | | | | |
| injection | | | | | |
| point | | | | | |

Combustion gas conditions at feedstock injection point

| | | | | | |
|---|---|---|---|---|---|
| Combustion T | 3004 | 3004 | 2995 | 2995 | 3004 |
| @ excess O₂ % | | | | | |
| % excess O₂, | 107% | 138% | 108% | 140% | 126% |
| (0 = | | | | | |
| stoichiometric) | | | | | |
| % O₂ | 10.73% | 10.73% | 10.78% | 10.77% | 10.63% |
| Heat input | 9.75 | 9.75 | 9.71 | 9.71 | 9.75 |
| above 77°(F.), | | | | | |
| MMBTU/hr | | | | | |

Volumetric heat input, BTU/scf

| | | | | | |
|---|---|---|---|---|---|
| based on | 65.07 | 62.12 | 64.84 | 62.20 | 64.99 |
| input gas | | | | | |
| rate | | | | | |
| based on | 64.64 | 66.18 | 64.41 | 66.14 | 69.70 |
| combustion | | | | | |
| gas rate | | | | | |

Breakdown of heat inputs at feedstock injection point

| | | | | | |
|---|---|---|---|---|---|
| MMBTU/hr | 6.66 | — | 6.63 | — | — |
| from NG | | | | | |
| combustion | | | | | |
| MMBTU/hr | — | 6.47 | — | 6.46 | 6.51 |
| from Flue | | | | | |
| Gas | | | | | |
| combustion | | | | | |
| MMBTU/hr | — | 1.07 | — | 1.12 | 1.49 |
| from flue | | | | | |
| gas preheat | | | | | |
| MMBTU/hr | 3.09 | 2.21 | 3.08 | 2.14 | 1.65 |
| from air/O₂ | | | | | |
| preheat | | | | | |
| Total heat | 9.75 | 9.75 | 9.71 | 9.71 | 9.75 |
| input above | | | | | |
| 77°(F.), | | | | | |
| MMBTU/hr | | | | | |

Composition of combustion gas at feedstock oil injection point

| | | | | | |
|---|---|---|---|---|---|
| % CO₂ | 5.0% | 7.9% | 5.0% | 8.9% | 8.6% |
| % H₂O | 10.7% | 13.2% | 10.6% | 12.0% | 32% |
| % N₂ | 74% | 68% | 74% | 68% | 48.5% |
| % O₂ | 10.73% | 10.73% | 10.78% | 10.77% | 10.63% |

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A process for making carbon black in a furnace-type reactor having a region into which feedstock oil is injected comprising:
supplying a hydrocarbon fuel to the reactor;
supplying air to the reactor to combust the hydrocarbon fuel and produce combustion gases;
injecting feedstock oil into the combustion gases to produce carbon black and a flue gas comprising hydrogen and oxides of carbon;
replacing the hydrocarbon fuel with a portion of the flue gas;
adding additional oxygen to the air supplied to the reactor to maintain the combustion gas temperature, oxygen concentration in the combustion gases, and total heat input rate in the region of the reactor into which feedstock oil is injected at about the same values which obtained when the hydrocarbon fuel was supplied to the reactor.

2. A process as recited in claim 1 further comprising removing a portion of the water vapor in the flue gas.

3. The process of claim 1 wherein the oxygen concentration in the combustion gases in the region of the reactor into which feedstock oil is injected is calculated from the temperature of the fuel supplied to the reactor, the rate at which fuel is supplied to the reactor, the temperature of the air supplied to the reactor, the rate at which air is supplied to the reactor and the oxygen content of the air supplied to the reactor.

4. A process as recited in claim 1 wherein the flue gas has a calorific value of about 150 BTU/scf.

5. A process as recited in claim 1 further comprising removing a portion of the oxides of nitrogen in the flue gas.

6. A process as recited in claim 1 wherein the oxygen added to the air supplied to the reactor is produced by a vacuum swing adsorption process.

7. A process as recited in claim 1 wherein the oxygen added to the air supplied to the reactor is produced by a pressure swing adsorption process.

8. A process for producing carbon black comprising:
(a) operating a furnace-type reactor using a hydrocarbon fuel to produce carbon black and a combustible flue gas;
(b) calculating the combustion gas temperature; percentage of oxygen at a selected point in the reactor, and the total heat input rate above a selected datum;
(c) replacing the hydrocarbon fuel with a portion of the combustible flue gas produced by the process;
(d) adjusting the flue gas input rate to provide about the same combustion gas temperature as that calculated in step (b);
(e) adjusting each of the air input rate, supplemental oxygen input rate, and fuel input rate by about the same percentage to achieve about the same total heat input rate above the selected datum as that calculated in step (b);
(f) calculating the resulting percentage of oxygen at the selected point in the reactor;
(g) adjusting the feed rate of supplemental oxygen and repeating steps (d) through (f), above until the calculated percentage of oxygen at the selected point in the reactor is about the same as that calculated in step (b); and,
(h) repeating steps (d) through (g) until the calculated combustion gas temperature; percentage of oxygen at the selected point in the reactor, and the total heat input rate above the selected datum are each about the same as that calculated in step (b).

9. A process as recited in claim 8 wherein the selected point in the reactor for calculating the percentage of oxygen is immediately upstream of the feedstock oil injection point.

10. A process as recited in claim 8 wherein the selected datum is 77° F.

11. A process for producing carbon black comprising:
(a) operating a furnace-type reactor using a hydrocarbon fuel to produce carbon black and a combustible flue gas;
(b) calculating the combustion gas temperature; percentage of oxygen at a selected point in the reactor, and the total heat input rate above a selected datum;
(c) replacing the hydrocarbon fuel with a portion of the combustible flue gas produced by the process;
(d) adjusting the flue gas input rate to provide about the same combustion gas temperature as that calculated in step (b);
(e) adjusting each of the air input rate, supplemental oxygen input rate, and fuel input rate by about the same percentage to achieve about the same total heat input rate above the selected datum as that calculated in step (b);
(f) calculating the resulting percentage of oxygen at the selected point in the reactor;
(g) selecting a desired percentage of oxygen at the selected point in the reactor;
(h) adjusting the feed rate of supplemental oxygen and repeating steps (d) through (f), above until the calculated percentage of oxygen at the selected point in the reactor is about the same as that selected in step (g); and,
(i) repeating steps (d), (e), (f) and (h) until the calculated combustion gas temperature and the total heat input rate above the selected datum are each about the same as that calculated in step (b) and the percentage of oxygen at the selected point in the reactor is about the same as that selected in step (g).

12. A process as recited in claim 11 wherein the selected point in the reactor for calculating the percentage of oxygen is immediately upstream of the feedstock oil injection point.

13. A process as recited in claim 11 wherein the selected datum is 77° F.

14. A method of controlling a furnace-type carbon black reactor comprising:
calculating the combustion gas temperature and the oxygen concentration in the combustion gas within a selected region of the reactor; and,
adjusting one or more parameters selected from the group consisting of fuel rate and oxygen content of the oxidizer stream to maintain approximately constant heat input rate at a constant combustion temperature, the combustion gas temperature and the oxygen concentration in the combustion gas within the selected region of the reactor.

15. A method as recited in claim 14 wherein the selected region of the reactor is the region in which feedstock oil is injected into the reactor.

16. A method as recited in claim 14 wherein the fuel supplied to the reactor is natural gas.

17. A method as recited in claim 14 wherein the fuel supplied to the reactor is a hydrocarbon.

18. A method as recited in claim 17 wherein the hydrocarbon is a liquid at room temperature and pressure.
